(19) United States
(12) Patent Application Publication
(10) Pub. No.: US 2025/0377819 A1
(43) Pub. Date: Dec. 11, 2025

(54) STORAGE SYSTEM AND VOLUME MIGRATION METHOD IN STORAGE SYSTEM

(71) Applicant: Hitachi Vantara, Ltd., Yokohama-shi (JP)

(72) Inventors: Akiyoshi TSUCHIYA, Tokyo (JP); Akira DEGUCHI, Tokyo (JP)

(21) Appl. No.: 19/075,999

(22) Filed: Mar. 11, 2025

(30) Foreign Application Priority Data
Jun. 11, 2024 (JP) 2024-094610

(51) Int. Cl. G06F 3/06

(52) U.S. Cl. CPC G06F 3/065; G06F 3/0619; G06F 3/0647; G06F 3/067

(57) ABSTRACT

In a system including a first storage system and a second storage system, there is a pair relationship of an copy between a first volume of the first storage system and a second volume of the second storage system. The system sets the second volume as a migration target and creates a copy volume of the second volume in another storage node of the second storage system. Difference data between the first volume and a snapshot of the first volume is reflected in the copy volume. A pair relationship of an copy is newly created between the first volume and the copy volume such that data related to an I/O request from a host to the first volume is reflected in the copy volume.

### CROSS-REFERENCE TO RELATED APPLICATION

The present application claims priority from Japanese application JP2024-094610, filed on Jun. 11, 2024, the content of which is hereby incorporated by reference into this application.

### BACKGROUND OF THE INVENTION

### 1. Field of the Invention

The present invention relates to a storage system and a volume migration method in a storage system.

### 2. Description of Related Art

In a storage system including a plurality of storage nodes, it is necessary to migrate a volume between nodes when rebalancing a load or capacity between nodes, removing a node, or the like. For example, Patent Literature 1 discloses a related-art technique for migrating one of two volumes for which a volume copy pair is created between storage controllers operating on different nodes.

### CITATION LIST

### Patent Literature

Patent Literature 1: U.S. Pat. No. 9,563,383

### SUMMARY OF THE INVENTION

However, in the above-described related-art technique, when migrating a volume for which a pair is created between storage controllers, it is necessary to temporarily suspend an I/O request from a host at a timing of switching a journal to be used before and after the migration. Therefore, user work related to host I/O may be affected.

The invention has been made in view of the above problems, and an object of the invention is to migrate a volume for which a pair is created between storage nodes without suspending an I/O request from a host in a storage system including a plurality of storage nodes.

In order to achieve the above object, the invention provides a storage system including storages each including a storage node, the storage node including a storage drive and a storage controller configured to process an I/O request from a host. A first of the storage includes a first volume in a first storage node, a second of the storage includes a second volume in a second storage node, a first pair relationship of an copy in which data related to the I/O request from the host to the first volume is reflected in the second volume is created between the first volume and the second volume, and the storage controller creates a snapshot of the first volume in the first storage, deletes the first pair relationship to stop the copy after creating the snapshot, migrates the first volume or the second volume as a migration target volume to another one of the storage node of the storage including the migration target volume while continuing processing of the I/O request from the host to the first volume, creates a second pair relationship of the copy between the first volume and the second volume after the migration of the first volume or the second volume to the other storage node is completed, compares the first volume and the snapshot and identifies difference data between the first volume and the snapshot after creating the second pair relationship, and reflects the identified difference data in the second volume.

According to the invention, in a storage system including a plurality of storage nodes, a volume for which a pair is created can be migrated between the storage nodes without suspending an I/O request from a host.

### BRIEF DESCRIPTION OF THE DRAWINGS

FIG. 1 is a diagram illustrating a processing overview of a storage system according to Embodiment 1.

FIG. 2 is a diagram illustrating a configuration of a storage node according to Embodiment 1.

FIG. 3 is a diagram illustrating a configuration of a memory of the storage node according to Embodiment 1.

FIG. 4 is a diagram illustrating a configuration of a storage management table according to Embodiment 1.

FIG. 5 is a diagram illustrating a configuration of a pool management table according to Embodiment 1.

FIG. 6 is a diagram illustrating a configuration of a volume management table according to Embodiment 1.

FIG. 7 is a diagram illustrating a configuration of a snapshot management table according to Embodiment 1.

FIG. 8 is a diagram illustrating a configuration of a node management table according to Embodiment 1.

FIG. 9 is a diagram illustrating a configuration of a volume mapping table according to Embodiment 1.

FIG. 10 is a diagram illustrating a configuration of a snapshot mapping table according to Embodiment 1.

FIG. 11 is a diagram illustrating a configuration of an asynchronous copy pair table according to Embodiment 1.

FIG. 12 is a diagram illustrating a configuration of a synchronous copy pair table according to Embodiment 1.

FIG. 13 is a diagram illustrating a configuration of a journal table according to Embodiment 1.

FIG. 14 is a diagram illustrating a difference bitmap according to Embodiment 1.

FIG. 15 is a diagram illustrating a copy area management bitmap according to Embodiment 1.

FIG. 16 is a sequence diagram illustrating copy destination volume migration processing according to Embodiment 1.

FIG. 17 is a flowchart illustrating snapshot creation processing according to Embodiment 1.

FIG. 18 is a flowchart illustrating pair creation processing by a differential copy according to Embodiment 1.

FIG. 19 is a flowchart illustrating copy area management bitmap creation processing according to Embodiment 1.

FIG. 20 is a flowchart illustrating difference identification processing according to Embodiment 1.

FIG. 21 is a flowchart illustrating copy metadata creation processing according to Embodiment 1.

FIG. 22 is a diagram illustrating a processing overview of a storage system according to Embodiment 2.

FIG. 23 is a sequence diagram illustrating copy source volume migration processing according to Embodiment 2.

FIG. 24A is a diagram illustrating a processing overview of a storage system according to Embodiment 3.

FIG. 24B is a diagram illustrating a processing overview of the storage system according to Embodiment 3.

FIG. 25 is a sequence diagram illustrating pair deleting processing considering a CTG according to Embodiment 3.

FIG. 26 is a sequence diagram illustrating resync processing for pair creation considering the CTG according to Embodiment 3.

FIG. 27 is a sequence diagram illustrating resync processing according to Embodiment 3.

FIG. 28A is a diagram illustrating a processing overview of a storage system according to Embodiment 4.

FIG. 28B is a diagram illustrating a processing overview of the storage system according to Embodiment 4.

FIG. 29 is a sequence diagram illustrating pair deleting processing considering a CTG according to Embodiment 4.

FIG. 30 is a sequence diagram illustrating resync processing for pair creation considering the CTG according to Embodiment 4.

### DESCRIPTION OF EMBODIMENTS

Hereinafter, embodiments of the invention will be described in detail with reference to the drawings.

In the following description, an “interface device” may be one or more communication interface devices. The one or more communication interface devices may be one or more communication interface devices of the same type (for example, one or more network interface card (NIC)) or two or more communication interface devices of different types (for example, an NIC and a host bus adapter (HBA)).

In the following description, a “memory” is one or more memory devices serving as an example of one or more storage devices and may be typically a main storage device. At least one memory device in the memory may be a volatile memory device or a non-volatile memory device.

In the following description, a “storage drive” is an example of one or more persistent storage devices. The persistent storage device may typically be a non-volatile storage device (for example, an auxiliary storage device), and specifically may be, for example, a hard disk drive (HDD), a solid state drive (SSD), or a non-volatile memory express (NVMe) drive.

In the following description, a “processor” may be one or more processor devices. At least one processor device may typically be a micro-processor device such as a central processing unit (CPU), but may also be another type of processor device such as a graphics processing unit (GPU). At least one processor device may be a single core or a multi-core. At least one processor device may be a processor core. At least one processor device may be a processor device in a broad sense, such as a hardware circuit (for example, a field-programmable gate array (FPGA), a complex programmable logic device (CPLD), or an application specific integrated circuit (ASIC)), in which some or all processing is executed.

In the following description, information from which an output is obtained in response to an input may be described using an expression such as “xxx table”. The information may be data of any structure (for example, structured data or unstructured data), or may be a learning model represented by a neural network, a genetic algorithm, or a random forest that generates an output in response to an input. Therefore, the “xxx table” can be referred to as “xxx information”. In the following description, a configuration of each table is an example. One table may be divided into two or more tables, or all or some of two or more tables may be one table.

In the following description, processing may be described using a “program” as the subject. The program is executed by the processor to perform predetermined processing while appropriately using a storage device and/or an interface device. Therefore, the subject of the processing may be a processor (or a device such as a controller having the processor). The program may be installed on a device such as a computer from a program source. The program source may be, for example, a program distribution server or a computer-readable (for example, non-transitory) recording medium. In the following description, two or more programs may be implemented as one program, or one program may be implemented as two or more programs.

In the following description, when elements of the same type are described without being distinguished from each other, a common portion (a portion excluding a subnumber) of reference numerals including subnumbers may be used, and when elements of the same type are described while being distinguished from each other, a reference numeral including a subnumber may be used. For example, a “storage node 10” may be described when storage nodes are not particularly distinguished, and a “storage node 10a” and a “storage node 10b” may be described when individual storage nodes such as a copy source and a copy destination of a volume are distinguished. As another description method when elements of the same type are described while being distinguished from each other, an ID (for example, an identification number) of the element may be used. Specifically, for example, a “journal 10Ja” and a “journal 10Ja2” may be described as a “journal #1” and a “journal #2”.

### Embodiment 1

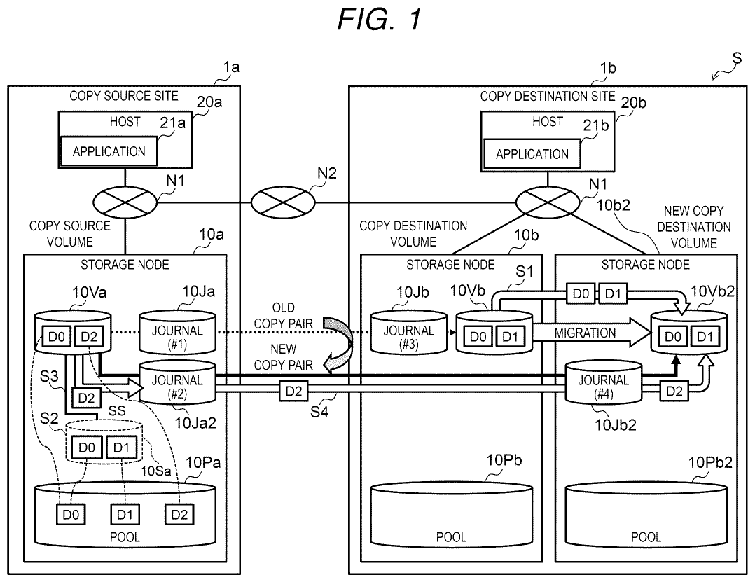

Hereinafter, Embodiment 1 of the invention will be described with reference to FIGS. 1 to 21.

### Processing Overview of System S According to Embodiment 1

FIG. 1 is a diagram illustrating a processing overview of a system S according to Embodiment 1. FIG. 1 illustrates control in the system S when migrating a copy destination volume in copy an destination site, which forms asynchronous copy pair with a copy source volume in a copy source site, between storage nodes in the copy destination site.

A volume 10Va in a storage node 10a in a copy source site la is copied to a storage node 10b in a copy destination site 1b. Data in the volume 10Va is written to a storage drive (not illustrated) via a pool 10Pa. At this time, a journal 10Ja (a journal #1) created in the storage node 10a of a copy source and a journal 10Jb (a journal #3) created in the storage node 10b of a copy destination are used.

The copy source site 1a and the copy destination site 1b are not limited to different remote sites, and may be the same site. That is, a storage system including the storage node 10a and a storage system including the storage node 10b and a storage node 10b2 may be disposed at the same site.

The journal 10Ja temporarily stores data related to update for the volume 10Va of the copy source. In the storage node 10b of the copy destination, data accumulated in the journal 10Ja is read and written to the journal 10Jb. Thereafter, the data accumulated in the journal 10Jb is reflected in a volume 10Vb of the copy destination. Accordingly, data is asynchronously copied from the volume 10Va of the copy source to the volume 10Vb of the copy destination. Data in the volume 10Vb is written to a storage drive (not illustrated) via a pool 10Pb.

A storage in the copy destination site 1b includes a plurality of storage nodes 10b and 10b2. In the copy destination site 1b, the volume 10Vb is rebalanced between the storage nodes 10b and 10b2 in order to level a load between the storage nodes 10b and 10b2.

At this time, when data is re-copied from the copy source site 1a to the copy destination site 1b to re-create a pair of an asynchronous copy in order to maintain a pair relationship of the asynchronous copy, an inconvenience of high network load between the copy source site 1a and the copy destination site 1b occurs.

Therefore, in the present embodiment, in order to avoid re-copying, a volume 10Vb2, which is a copy volume (a second copy volume) of a synchronous copy of the volume 10Vb, is created at the copy destination site 1b. Then, volume migration is performed from the volume 10Vb in the storage node 10b to the volume 10Vb2 in the storage node 10b2 while maintaining the pair relationship of the asynchronous copy.

A migration method of a copy destination volume from the volume 10Vb to the volume 10Vb2 is as follows. First, in step S1, the volume 10Vb of the copy destination is synchronously copied between the storage nodes 10b and 10b2 (data D0 and data D1 are copied to the volume Vb2).

Next, in step S2, a snapshot 10Sa of the volume 10Va of the copy source is created in the storage node 10a of the copy source. When the snapshot 10Sa is created, the pair relationship of the asynchronous copy between the volume 10Va and the volume 10Vb is deleted. The snapshot 10Sa is used for subsequent stage difference identification. The copy of the copy source volume is not limited to the snapshot as long as the subsequent stage difference identification can be performed, and another type of copy can be used.

Here, in the volume 10Va of the copy source, there is difference data D2 that is not yet copied to the volume 10Vb of the copy destination. When only the difference data D2 is copied, a new volume 10Vb2 of the copy destination has data same as that in the volume 10Va of the copy source. That is, the copy destination volume can be migrated with the pair relationship of the asynchronous copy established.

Therefore, in step S3, the snapshot 10Sa and the volume 10Va of the copy source are compared, and it is identified that the difference data D2 is a difference. Next, in step S4, the identified difference data D2 is copied to the volume 10Vb2, and a pair relationship of an asynchronous copy is established between volume pairs of the volume 10Va of the copy source and the new volume 10Vb2 of the copy destination.

At this time, a journal 10Jb2 (a journal #4) is created in the storage node 10b2 of a volume migration destination, and a journal 10Ja2 (a journal #2) paired with the journal 10Jb2 is created in the storage node 10a of the copy source. The difference data D2 is copied to the volume 10Vb2 via the journal 10Ja2 and the journal 10Jb2. Data in the volume 10Vb2 is written to a storage drive (not illustrated) via a pool 10Pb2.

### Configuration of Storage Node 10 According to Embodiment 1

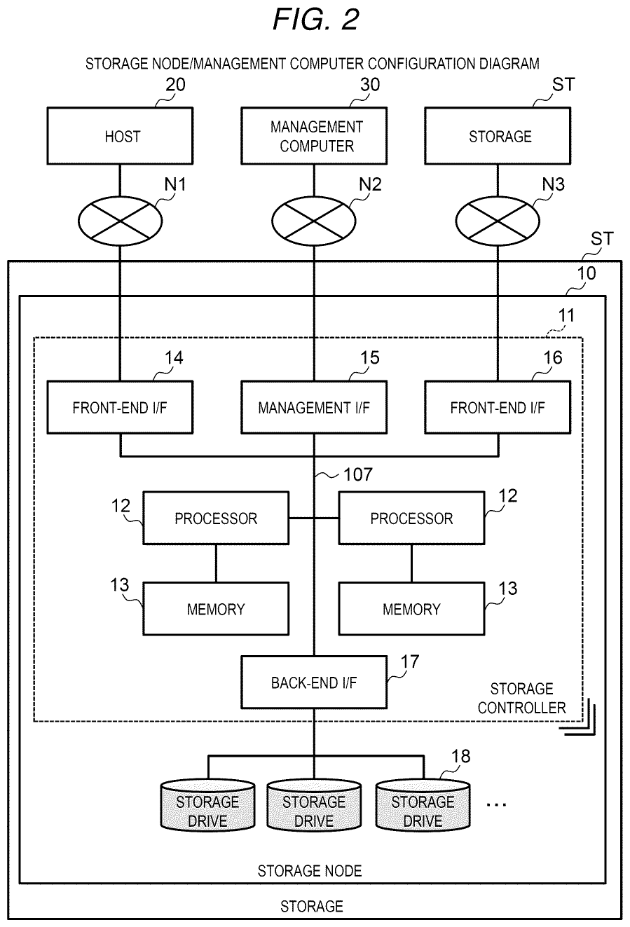

FIG. 2 is a diagram illustrating a configuration of the storage node 10 according to Embodiment 1. A storage ST including one or a plurality of storage nodes 10 is disposed in each site. The storage node 10 is connected to a host 20 via a network N1 and receives an input/output (I/O) request from the host 20. The storage ST is an example of a first storage system including a storage node and a second storage system including a storage node that are provided in the system S (FIG. 1).

The storage node 10 is connected to a management computer 30 via a network N2, and a configuration of the storage or the like is managed by the management computer 30. The storage node 10 is connected to the storage ST in another site via a network N3, and performs an asynchronous copy of a volume with the storage ST in the other site. The networks N1, N2, and N3 may be the same network or different networks.

The storage node 10 includes one or a plurality of storage controllers 11. The storage controller 11 includes one or a plurality of processors 12, one or a plurality of volatile or non-volatile memories 13, front-end inter/faces (I/F) 14 and 16, a management I/F 15, and a back-end I/F 17. One or a plurality of storage drives 18 having a physical persistent storage area are connected to the storage node 10.

The processor 12 receives data related to an I/O request from the host 20 via the front-end I/F 14, and processes the data by accessing the storage drive 18 via the back-end I/F 17 while caching the data in the memory 13. The processor 12 manages the storage drive 18 via the back-end I/F 17 based on a command for management of a configuration or the like that is received from the management computer 30 via the management I/F 15.

The processor 12 reads data stored in a logically configured volume from a storage area of the storage drive 18, which is provided to the host 20, and copies the data to the storage node 10b in another site via the front-end I/F 16.

### Configuration of Memory 13 of Storage Node 10 According to Embodiment 1

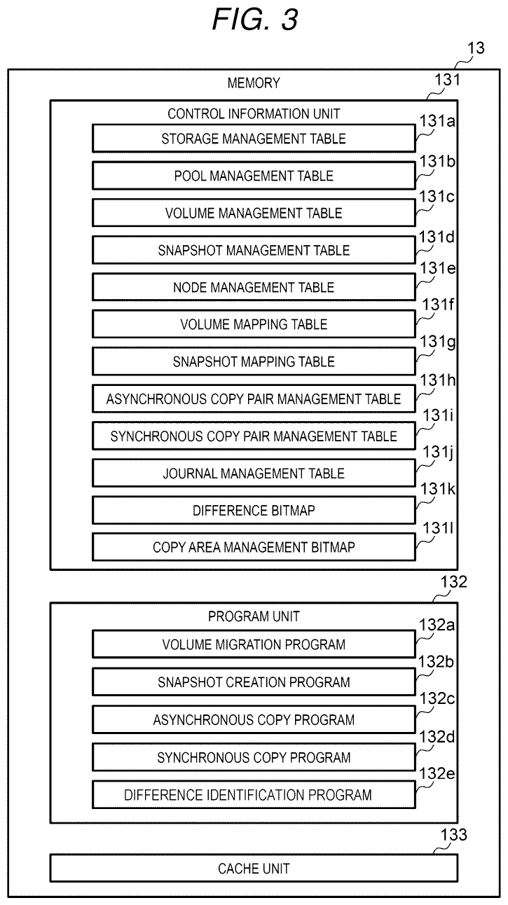

FIG. 3 is a diagram illustrating a configuration of the memory 13 of the storage node 10 according to Embodiment 1. The memory 13 includes a control information unit 131 which is a storage area of control information, a program unit 132 which is a storage area of a program, and a cache unit 133 which is a temporary storage area of data related to I/O from the host 20.

The control information unit 131 stores a storage management table 131a, a pool management table 131b, a volume management table 131c, a snapshot management table 131d, a node management table 131e, and a volume mapping table 131f. The control information unit 131 stores a snapshot mapping table 131g, an asynchronous copy pair management table 131h, a synchronous copy pair management table 131i, and a journal management table 131j. The control information unit 131 stores a difference bitmap 131k and a copy area management bitmap 131l.

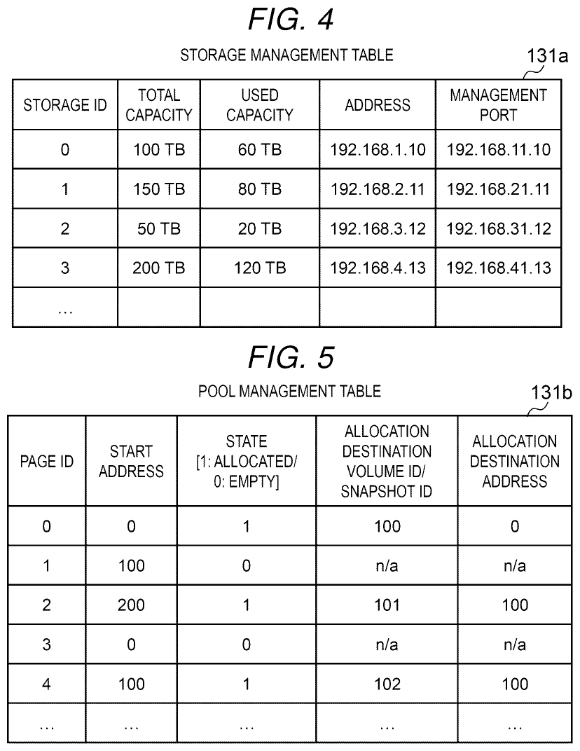

As illustrated in FIG. 4, the storage management table 131a includes columns for “storage ID”, “total capacity”, “used capacity”, “address”, and “management port”. The storage management table 131a is management information of the storage node 10 constituting the storage ST.

The “storage ID” is identification information of each storage ST including the storage node 10. The “total capacity” is capacity information of the corresponding storage ST. The “used capacity” is used capacity information of the corresponding storage ST. The “address” is information for accessing each storage ST with respect to the I/O, and is indicated by an IP address as an example. The “management port” is information for accessing the corresponding storage ST with respect to management of a configuration or the like, and a port is indicated by an IP address as an example.

As illustrated in FIG. 5, the pool management table 131b includes columns for “page ID”, “start address”, “state”, “allocation destination volume ID/snapshot ID”, and “allocation destination address”. The pool management table 131b is information for managing a usage status of a pool in units of pages, which are areas of a fixed size.

The “page ID” is identification information of each page. The “start address” indicates an address (a position) in a pool of the corresponding page. The “state” indicates a usage status of the corresponding page, that is, whether the corresponding page is allocated to a volume or a snapshot. The “allocation destination volume ID/snapshot ID” indicates an ID of a volume or snapshot to which the corresponding page is allocated. The “allocation destination address” indicates an allocation location of a volume or a snapshot to which the corresponding page is allocated (an address in a volume or a snapshot).

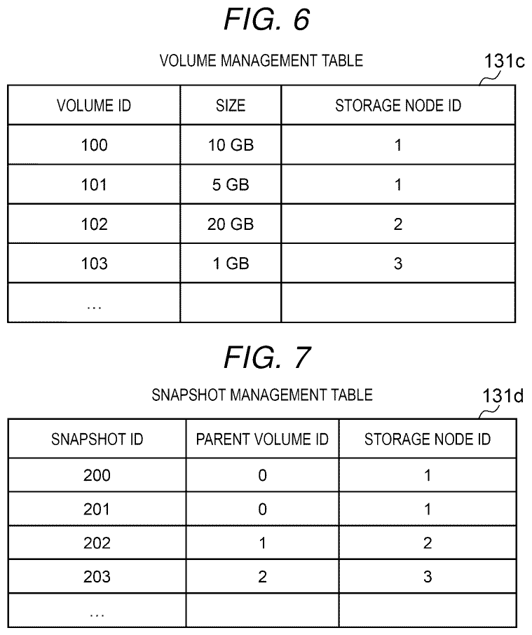

As illustrated in FIG. 6, the volume management table 131c includes columns for “volume ID”, “size”, and “storage node ID”. The volume management table 131c is control information for managing volumes. The “volume ID” is identification information of each volume. The “size” is size information of the corresponding volume. The “storage node ID” is identification information of a storage node that manages the corresponding volume.

As illustrated in FIG. 7, the snapshot management table 131d includes columns for “snapshot ID”, “parent volume ID”, and “storage node ID”. The snapshot management table 131d is control information for managing snapshots.

The “snapshot ID” is identification information of each snapshot. The “parent volume ID” is identification information of a parent volume which is a creation source of the corresponding snapshot. The “storage node ID” is identification information of a storage node including the corresponding snapshot.

The snapshot management table 131d can be omitted when it is clear that the snapshot is managed by the storage node 10 same as that for the parent volume. In this case, the storage node is identified by referring to the “volume ID” corresponding to the parent volume in the volume management table 131c.

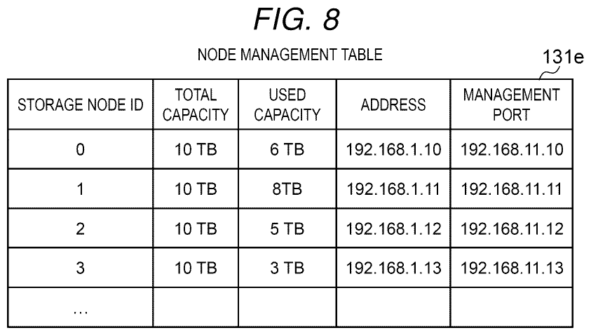

As illustrated in FIG. 8, the node management table 131e includes columns for “storage node ID”, “total capacity”, “used capacity”, “address”, and “management port”. The node management table 131e is information for managing the storage node 10.

The “storage node ID” is identification information of each storage node 10. The “total capacity” is capacity information of the corresponding storage node 10. The “used capacity” is used capacity information of the corresponding storage node 10. The “address” is information for accessing each storage node 10 with respect to the I/O, and is indicated by an IP address as an example. The “management port” is information for accessing the corresponding storage node 10 with respect to management of a configuration or the like, and a port is indicated by an IP address as an example.

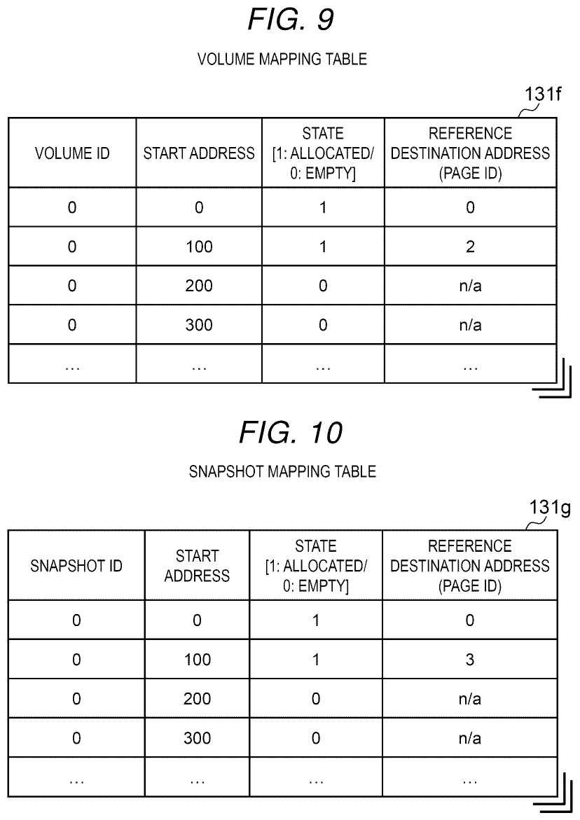

As illustrated in FIG. 9, the volume mapping table 131f includes columns for “volume ID”, “start address”, “state”, and “reference destination address”. The volume mapping table 131f is information for managing allocation states of pages to volumes.

The “volume ID” is identification information of each volume. The “start address” indicates an address of the corresponding volume (a start position of the volume). The “state” indicates whether a page is allocated. The “reference destination address” is identification information of an allocated page. Since a page is allocated when data is written to a volume for the first time, an area to which data is never written is an unallocated page.

As illustrated in FIG. 10, the snapshot mapping table 131g includes columns for “snapshot ID”, “start address”, “state”, and “reference destination address”. The snapshot mapping table 131g is information for managing allocation states of pages to snapshots, similar to the volume mapping table 131f for managing allocation states of pages to volumes. Each column in the snapshot mapping table 131g is similar to that in the volume mapping table 131f, except that a target is changed from a volume to a snapshot.

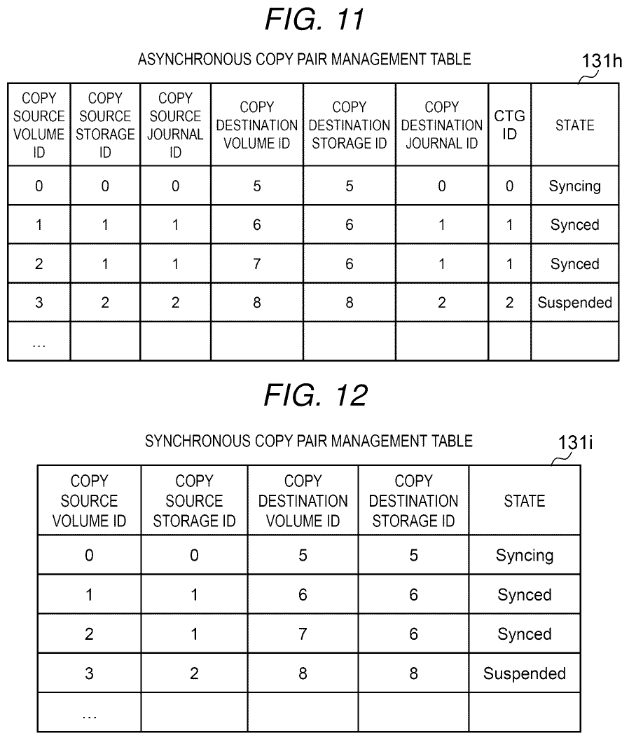

As illustrated in FIG. 11, the asynchronous copy pair management table 131h has columns for “copy source volume ID”, “copy source storage ID”, and “copy source journal ID”. The asynchronous copy pair management table 131h includes columns for “copy destination volume ID”, “copy destination storage ID”, “copy destination journal ID”, “CTG ID”, and “state”. The asynchronous copy pair management table 131h is information for managing pairs of an asynchronous copy.

The “copy source volume ID” is identification information of a copy source volume. The “copy source storage ID” is identification information of a copy source storage. The “copy source journal ID” is identification information of a copy source journal. The “copy destination volume ID”, the “copy destination storage ID”, and the “copy destination journal ID” indicate identification information of a copy destination volume, identification information of a copy destination storage, and identification information of a copy destination journal, respectively.

The “CTG ID” is identification information of a consistency group (CTG). The CTG is a group of a plurality of copy pairs configured to maintain consistency (a write order) when copying a plurality of volumes. The “state” indicates whether a copy state of data in the corresponding copy pair is syncing, synced, or suspended.

As illustrated in FIG. 12, the synchronous copy pair management table 131i includes columns for “copy source volume ID”, “copy source storage ID”, “copy destination volume ID”, “copy destination storage ID”, and “state”. The synchronous copy pair management table 131i is information for managing pairs of a synchronous copy.

The “copy source volume ID” is identification information of a copy source volume. The “copy source storage ID” is identification information of a copy source storage. The “copy destination volume ID” and the “copy destination storage ID” indicate identification information of a copy destination volume and identification information of a copy destination storage, respectively. The “state” indicates whether a copy state of data in the corresponding copy pair is syncing, synced, or suspended.

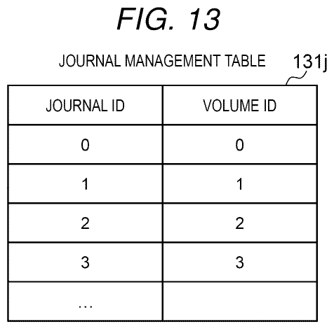

As illustrated in FIG. 13, the journal management table 131j includes columns for “journal ID” and “volume ID”. The journal management table 131j is information for managing journals used for an asynchronous copy. The “journal ID” is identification information of each journal. The “volume ID” is identification information of a volume for temporarily storing data to be copied.

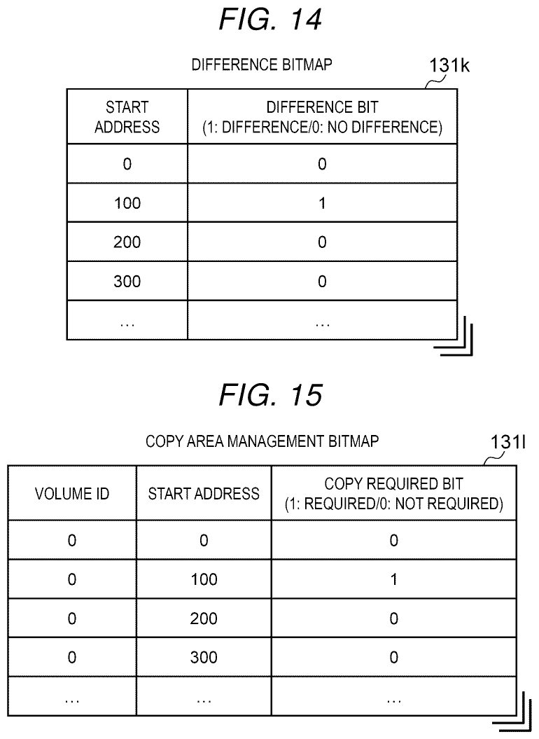

As illustrated in FIG. 14, the difference bitmap 131k includes columns for “start address” and “difference bit”. The difference bitmap 131k is information for managing a result obtained by comparing a volume and a snapshot thereof for each page of the volume and identifying a difference portion which is a portion having a difference in data. The “start address” indicates a start address of a page of a volume. The “difference bit” indicates the presence or absence of a difference.

As illustrated in FIG. 15, the copy area management bitmap 131l includes columns for “volume ID”, “start address”, and “copy required bit”. The copy area management bitmap 131l is information indicating whether data copy is required for each page of a copy source volume. The “volume ID” is identification information of each copy source volume. The “start address” is a start address of a page of a copy source volume. The “copy required bit” indicates whether the corresponding page is required to be copied. When the “copy required bit” is “1” (copy is required), metadata for copying the corresponding page is stored in a journal when a copy pair is created. When a copy source storage receives a request for a copy destination storage to read data from a journal, in a case where the metadata is stored in the journal, the copy source storage reads the corresponding page based on the metadata and returns the data to the copy destination storage. Accordingly, the data of the corresponding page is copied from the copy source storage to the copy destination storage.

The program unit 132 stores a volume migration program 132a, a snapshot creation program 132b, an asynchronous copy program 132c, a synchronous copy program 132d, and a difference identification program 132e.

### Copy Destination Volume Migration Processing According to Embodiment 1

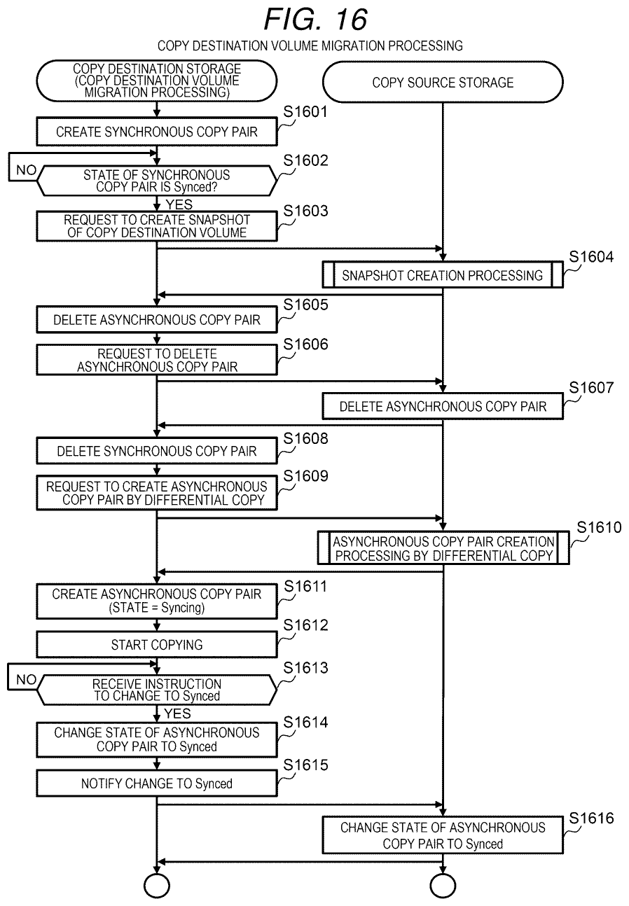

FIG. 16 is a sequence diagram illustrating copy destination volume migration processing according to Embodiment 1. The copy destination volume migration processing can be implemented by the storage controller 11 that executes the volume migration program 132a (FIG. 3). The copy destination volume migration processing can be executed by the storage controller 11 of the storage ST of a copy destination when rebalancing or node removal is implemented due to a load on the storage node 10 of the copy destination exceeding a threshold value.

First, in step S1601, the storage controller 11 of the storage ST of the copy destination (hereinafter, “copy destination storage controller”) creates a volume in the storage node 10 of a migration destination to which the storage node 10 of the copy destination is to be migrated. Then, a synchronous copy pair is created with the migration target volume as a copy source and the created volume (the migration destination volume) as a copy destination.

Next, in step S1602, the copy destination storage controller waits until a copy between the synchronous copy pair created in step S1601 is completed (a copy state is synced). The copy destination storage controller moves the processing to step S1603 when the copy is completed (YES in step S1602), and repeats step S1602 while the copy is not completed (NO in step S1602).

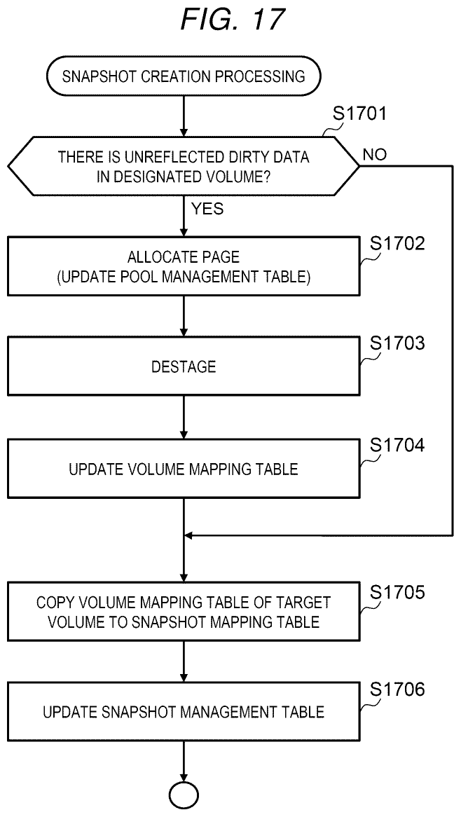

In step S1603, the copy destination storage controller requests the storage ST of a copy source to create a snapshot of the copy source volume. The storage controller 11 of the storage ST of the copy source (hereinafter, “copy source storage controller”) executes snapshot creation processing according to an instruction of step S1603. Details of the snapshot creation processing will be described later with reference to FIG. 17.

Next, in step S1605, upon receiving a completion notification of step S1604 from the copy source storage controller, the copy destination storage controller deletes the current asynchronous copy pair in the own storage.

Next, in step S1606, the copy destination storage controller requests the copy source storage controller to delete the current asynchronous copy pair. In step S1607, the copy source storage controller deletes the asynchronous copy pair requested to be deleted in step S1606. In the example in FIG. 1, the asynchronous copy pair deleted in steps S1605 and S1607 is a pair relationship between the volume 10Va and the volume 10Vb.

At the time of step S1607, all data stored in the journal but not yet copied is copied and reflected in the copy destination volume of the copy destination storage.

Next, in step S1608, the copy destination storage controller deletes the synchronous copy pair created in step S1601. In the example in FIG. 1, the volume 10Vb of the copy source may also be deleted.

Next, in step S1609, the copy destination storage controller sets the migration destination volume created in step S1601 as the copy destination and the current copy source volume as the copy source, and requests the copy source storage controller to create an asynchronous copy pair by a differencial copy. When a journal for copying data to the migration destination volume does not exist in both the copy source storage and the copy destination storage, the journal is created to exist in both the copy source storage and the copy destination storage before the processing of step S1609.

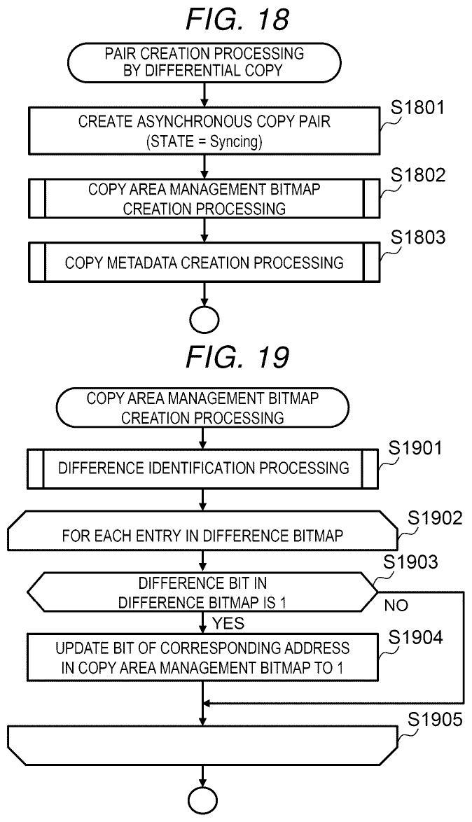

In step S1610, the copy source storage controller executes asynchronous copy pair creation processing by a differential copy in accordance with the request in step S1609. Details of the asynchronous copy pair creation processing by a differential copy will be described later with reference to FIG. 18.

Next, in step S1611, upon receiving a completion notification of step S1610 from the copy source storage controller, the copy destination storage controller creates an entry for the asynchronous copy pair in the asynchronous copy pair management table 131h based on the reception result.

Next, in step S1612, the copy destination storage controller starts copying of the asynchronous copy pair for which an entry is created in the asynchronous copy pair management table 131h. The copying is performed by reading data from a journal in the copy source storage, temporarily storing the data in a journal in the copy destination storage, and then reflecting the data in the copy destination volume. At this time, the copying based on the metadata created based on the copy area management bitmap 131l is as described in FIG. 15.

Next, in step S1613, the copy destination storage controller determines whether special data instructing transition to a synced state is included in the data read from the journal. The copy destination storage controller moves the processing to step S1614 when the special data instructing transition to a Synced state is included (YES in step S1613), and repeats step S1613 when the special data is not included (NO in step S1613).

Next, in step S1614, the copy destination storage controller changes a state of the corresponding asynchronous copy pair to synced. Next, in step S1615, the copy destination storage controller notifies the copy source storage controller of the completion of the change to synced.

Next, in step S1616, upon receiving the completion of the change to synced from the copy destination storage controller, the copy source storage controller changes the state of the corresponding asynchronous copy pair managed by the copy source storage to synced.

### Snapshot Creation processing According to Embodiment 1

FIG. 17 is a flowchart illustrating the snapshot creation processing according to Embodiment 1. The snapshot creation processing can be implemented by the storage controller 11 that executes the snapshot creation program 132b (FIG. 3).

First, in step S1701, the copy source storage controller determines whether dirty data written in a designated volume but not reflected in the storage drive 18 exists in a cache memory (the cache unit 133). The copy source storage controller moves the processing to step S1702 when the dirty data exists in the cache memory (YES in step S1701), and moves the processing to step S1704 when the dirty data does not exist (NO in step S1701).

In step S1702, the copy source storage controller updates the pool management table 131b and allocates a page of a pool to the dirty data. Next, in step S1703, the copy source storage controller destages the dirty data from the cache memory and writes the dirty data to the storage drive 18. Next, in step S1704, the copy source storage controller maps the page allocated in step S1702 to the volume and updates the volume mapping table 131f.

Next, in step S1705, the copy source storage controller copies an entry for the volume for which the snapshot is to be created in the volume mapping table 131f to the snapshot mapping table 131g, and creates an entry for the snapshot. Next, in step S1706, information on the snapshot created in step S1705 is added to the snapshot management table 131d.

### Pair Creation Processing by Differential copy According to Embodiment 1

FIG. 18 is a flowchart illustrating the pair creation processing by a differential copy according to Embodiment 1.

First, in step S1801, the copy source storage controller creates information for managing the target asynchronous copy pair in the asynchronous copy pair management table 131h. In step S1801, “state =syncing” is registered in the asynchronous copy pair management table 131h.

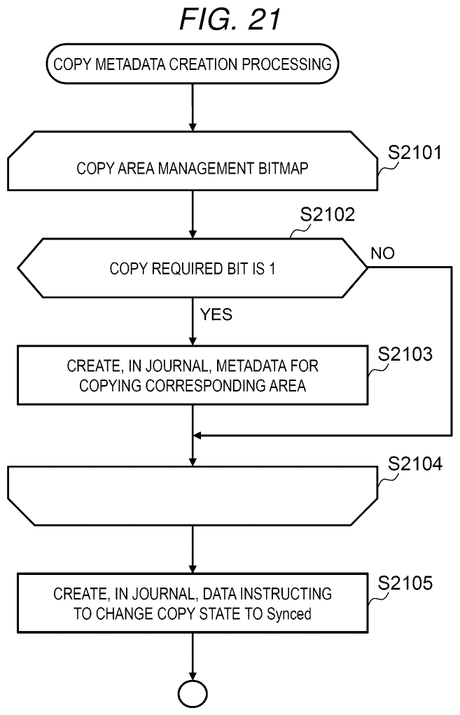

Next, in step S1900, the copy source storage controller executes copy area management bitmap creation processing. Details of the copy area management bitmap creation processing will be described later with reference to FIG. 19. Next, in step S1803, the copy source storage controller executes copy metadata creation processing. Details of the copy metadata creation processing will be described later with reference to FIG. 21.

### Copy Area Management Bitmap Creation Processing According to Embodiment 1

FIG. 19 is a flowchart illustrating the copy area management bitmap creation processing according to Embodiment 1. The copy area management bitmap creation processing is called from the pair creation processing by a differential copy (step S1802 in FIG. 18), and creates a bitmap for managing the copy area.

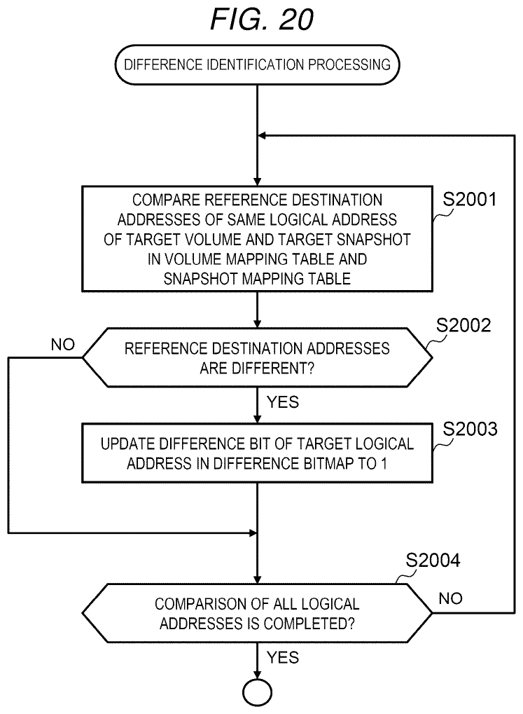

First, in step S1901, the copy source storage controller executes difference identification processing. Details of the difference identification processing will be described later with reference to FIG. 20. Next, in step S1902, the copy source storage controller selects one unselected entry in the difference bitmap 131k created in step S1901.

Next, in step S1903, the copy source storage controller determines whether the difference bit in the difference bitmap 131k is 1. The copy source storage controller confirms the entry for the difference bitmap 131k, moves the processing to step S1904 when the difference bit in the difference bitmap 131k is 1, and moves the processing to step S1905 when the difference bit is 0.

In step S1904, the copy source storage controller updates the copy required bit in the copy area management bitmap 131l to 1 for an address same as the address indicated by the corresponding entry whose difference bit is 1 in step S1903, i.e., in which there is a difference.

Next, in step S1905, when there is an unselected entry in the difference bitmap 131k in step S1902, the copy source storage controller returns the processing to step S1902 and selects the unselected entry. When all entries in the difference bitmap 131k are selected in step S1902, the copy source storage controller ends the copy area management bitmap creation processing.

### Difference Identification processing According to Embodiment 1

FIG. 20 is a flowchart illustrating the difference identification processing according to Embodiment 1. The difference identification processing can be implemented by the storage controller 11 that executes the difference identification program 132e (FIG. 3).

First, in step S2001, the copy source storage controller compares reference destination addresses of the same logical address of a target volume and a target snapshot in the volume mapping table 131f and the snapshot mapping table 131g.

Next, in step S2002, the copy source storage controller determines whether the reference destination addresses compared in step S2001 are different. The copy source storage controller moves the processing to step S2003 when the reference destination addresses are different (YES in step S2002), and moves the processing to step S2004 when the reference destination addresses match (NO in step S2002).

In step S2003, the copy source storage controller updates, to 1, the difference bit in the difference bitmap 131k that corresponds to the reference destination address identified as different in step S2002. Next, in step S2004, the copy source storage controller determines whether comparison of all logical addresses is completed in step S2001. The copy source storage controller ends the difference identification processing when the comparison of all the logical addresses is completed in step S2001 (YES in step S2004), and returns the processing to step S2001 when the comparison is not completed (NO in step S2004).

### Copy Metadata Creation Processing According to Embodiment 1

FIG. 21 is a flowchart illustrating the copy metadata creation processing according to Embodiment 1. The copy metadata creation processing is processing in which metadata for data copying is created in a journal by the copy source storage at the time of synchronous copy pair creation (step S1601 of the copy destination volume migration processing (FIG. 16)).

The journal normally stores data written to the copy source volume and metadata thereof (a volume and a write position (a logical address) thereof). However, during an initial copy when creating a pair, since saving all of the data in the volume to the journal is a heavy load, only metadata is stored. When the metadata is called from the journal by the copy destination storage, the data is read from the copy source volume and transmitted to the copy destination storage.

First, in step S2101, the copy source storage controller selects one unselected entry in the copy area management bitmap 131l. Next, in step S2102, the copy source storage controller determines whether the copy required bit of the entry selected in step S2101 is 1. The copy source storage controller moves the processing to step S2103 when the copy required bit is 1 (YES in step S2102), and moves the processing to step S2104 when the copy required bit is 0 (NO in step S2102).

In step S2103, the copy source storage controller creates, in the journal, metadata for copying an area (a page) in which the copy required bit is determined to be 1 in step S2102. Next, in step S2104, when there is an unselected entry in the copy area management bitmap 131l in step S2101, the copy source storage controller returns the processing to step S2102 and selects the unselected entry. When all the entries in the copy area management bitmap 131l are selected in step S2101, the copy source storage controller moves the processing to step S2105.

In step S2105, when the metadata creation is completed for all areas (pages) in which the copy required bit is 1, the copy source storage controller creates, in the journal, metadata for instructing to change the copy state to Synced. When reading the metadata, the copy destination storage controller changes the state of the asynchronous copy pair to synced.

### Embodiment 2

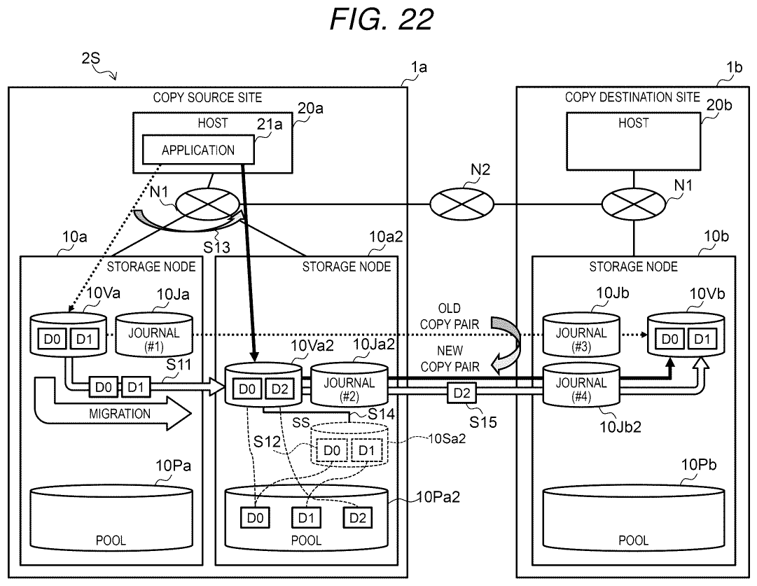

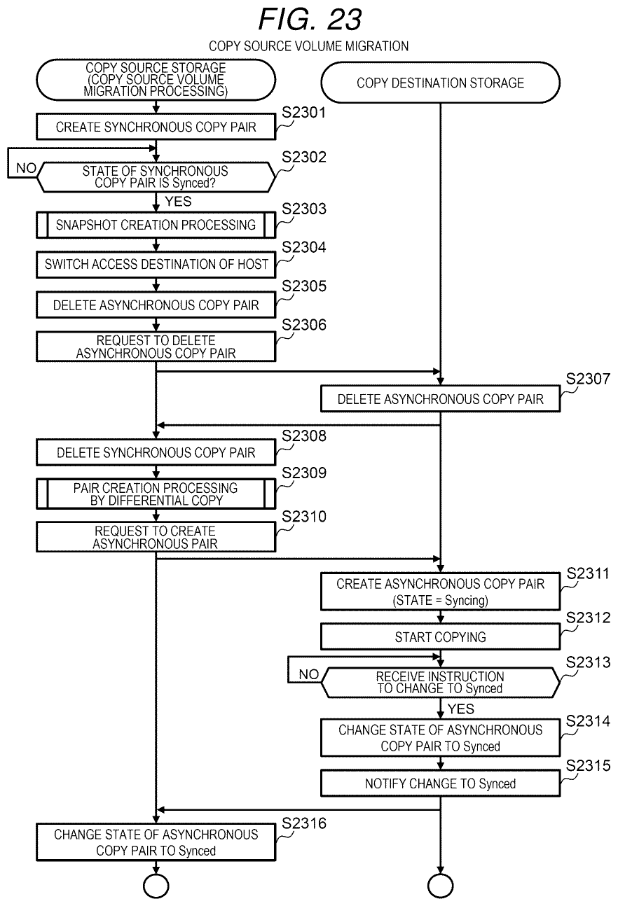

Hereinafter, Embodiment 2 of the invention will be described with reference to FIGS. 22 and 23. In the description of Embodiment 2, differences from Embodiment 1 will be mainly described, and redundant description will be omitted.

### Processing Overview of Storage System According to Embodiment 2

FIG. 22 is a diagram illustrating a processing overview of a storage system according to Embodiment 2. FIG. 22 illustrates control in a storage system 2S when migrating a copy source volume in a copy source site, which forms an asynchronous copy pair with a copy destination volume in a copy destination site, between storage nodes in the copy source site.

A storage in the copy source site 1a includes a plurality of storage nodes 10a and 10a2. In the copy source site 1a, the volume 10Va is rebalanced between the storage nodes 10a and 10a2 in order to level a load between the storage nodes 10a and 10a2.

In the present embodiment, in the copy source site 1a, a volume 10Va2, which is a copy volume (a first copy volume) of a synchronous copy of the volume 10Va, is created. Then, by performing volume migration from the volume 10Va in the storage node 10a to the volume 10Va2 in the storage node 10a2 while maintaining a pair relationship of an asynchronous copy, recopying of data is avoided.

A migration method of a copy source volume from the volume 10Va to the volume 10Va2 is as follows. First, in step S11, the volume 10Va of the copy source is synchronously copied between the storage nodes 10a and 10a2 (data D0 and data D1 are copied to the volume 10Va2).

Next, in step S12, a snapshot 10Sa2 of the volume 10Va2 of the copy source is created in the storage node 10a2 of the copy source. When the snapshot 10Sa2 is created, a pair relationship of an asynchronous copy between the volume 10Va and the volume 10Vb is deleted. The snapshot 10Sa2 is used for subsequent stage difference identification. The copy of the copy source volume is not limited to the snapshot as long as the subsequent stage difference identification can be performed, and another type of copy can be used.

Next, in step S13, an access destination of an I/O request from a host 20a is switched to the volume 10Va2 of a synchronous copy destination. Since the host 20a continues updating data, subsequent data updates are added to the volume 10Va2 of the synchronous copy destination (the difference data D2 is added in FIG. 22).

Next, in step S14, the snapshot 10Sa2 and the volume 10Va2 are compared, and it is identified that the difference data D2 is a difference. Next, in step S15, the identified difference data D2 is copied to the volume 10Vb, and a pair relationship of an asynchronous copy is established between a new volume 10Va2 of the copy source and the volume 10Vb of the copy destination.

At this time, the journal 10Ja2 (the journal #2) is created in the storage node 10a2 of a volume migration destination, and the journal 10Jb2 (the journal #4) paired with the journal 10Ja2 is created in the storage node 10b of the copy destination. The difference data D2 is copied to the volume 10Vb2 via the journal 10Ja2 and the journal 10Jb2. Data in the volume 10Va2 is written to a storage drive (not illustrated) via a pool 10Pa2.

### Copy Source Volume Migration Processing According to Embodiment 2

FIG. 23 is a sequence diagram illustrating copy source volume migration processing according to Embodiment 2. The copy source volume migration processing can be implemented by the storage controller 11 that executes the volume migration program 132a (FIG. 3). The copy source volume migration processing can be executed by the storage controller 11 of the storage ST of the copy source when rebalancing or node removal is implemented due to a load on the storage node 10 of the copy source exceeding a threshold value.

First, in step S2301, a copy source storage controller creates a volume in a migration destination node, and creates a synchronous copy pair with a migration target volume as a copy source and the created volume as a copy destination. The copy destination volume is a migration destination volume.

Next, in step S2302, the copy source storage controller waits until a copy between the synchronous copy pair created in step S2301 is completed (a copy state is synced). The copy source storage controller moves the processing to step S2303 when the copy is completed (YES in step S2302), and repeats step S2302 while the copy is not completed (NO in step S2302).

In step S2303, the copy source storage controller executes snapshot creation processing. Details of the snapshot creation processing are as illustrated in FIG. 17. An execution subject of the snapshot creation processing called in step S2303 is the copy source storage controller.

Next, in step S2304, the copy source storage controller switches an access destination of the host 20a from the migration target volume to the migration destination volume. Next, in step S2305, the copy source storage controller deletes the current asynchronous copy pair in the own storage.

Next, in step S2306, the copy source storage controller requests the copy destination storage to delete the current asynchronous copy pair. In step S2307, the copy destination storage controller deletes the asynchronous copy pair requested to be deleted in step S2306. In the example in FIG. 22, the asynchronous copy pair deleted in steps S2305 and S2307 is a pair relationship between the volume 10Va and the volume 10Vb.

In step S2307, the copy destination storage controller copies and reflects all data, which is stored in the journal but is not yet copied, in the copy destination volume in the copy destination storage.

Next, in step S2308, the copy source storage controller deletes the synchronous copy pair created in step S2301. In the example in FIG. 22, the volume 10Va of the copy source may also be deleted.

Next, in step S2309, the copy source storage controller executes copy pair creation processing by a differential copy. Details of the copy pair creation processing by a differential copy are as illustrated in FIG. 18. In step S2309, the copy source storage controller sets the migration destination volume created in step S2301 as the copy source and the current copy destination volume as the copy destination, and creates an asynchronous copy pair by the differential copy.

When a journal for copying data to the migration destination volume does not exist in both the copy source storage and the copy destination storage, the journal is created to exist in both the copy source storage and the copy destination storage before the processing of step S2309.

Next, in step S2310, the copy source storage controller requests the copy destination storage controller to create an asynchronous copy pair. In step S2311, upon receiving the asynchronous copy pair creation request from the copy source storage controller, the copy destination storage controller creates an entry for the asynchronous copy pair in the asynchronous copy pair management table 131h.

Next, in step S2312, the copy destination storage controller starts copying of the asynchronous copy pair for which an entry is created in the asynchronous copy pair management table 131h. The copying is performed by reading data from a journal in the copy source storage, temporarily storing the data in a journal in the copy destination storage, and then reflecting the data in the copy destination volume.

Next, in step S2313, the copy destination storage controller determines whether special data instructing transition to a synced state is included in the data read from the journal. The copy destination storage controller moves the processing to step S2314 when the special data instructing transition to a synced state is included (YES in step S2313), and repeats step S2313 when the special data is not included (NO in step S2313).

Next, in step S2314, the copy destination storage controller changes a state of the corresponding asynchronous copy pair to synced. Next, in step S2315, the copy destination storage controller notifies the copy source storage controller of the completion of the change to synced.

Next, in step S2316, upon receiving the completion of the change to synced from the copy destination storage controller, the copy source storage controller changes the state of the corresponding asynchronous copy pair managed by the copy source storage to synced.

### Effects of Embodiments 1 and 2

In Embodiments 1 and 2 described above, the volume is migrated between the storage nodes by identifying the difference between the copy source volume and the copy destination volume using the snapshot and creating the asynchronous copy pair only by the differential copy. By migrating the volume having the asynchronous copy pair between the storage nodes, the load between the storage nodes can be leveled while avoiding the performance influence on the application without suspending the I/O request from the host. The storage node in which the volume having the asynchronous copy pair exists can be migrated to another storage node while avoiding the performance influence on the application without temporarily suspending the I/O request from the host, and the corresponding storage node can be removed. Therefore, the excess resources of the storage can be reduced, and the cost can be reduced.

### Embodiment 3

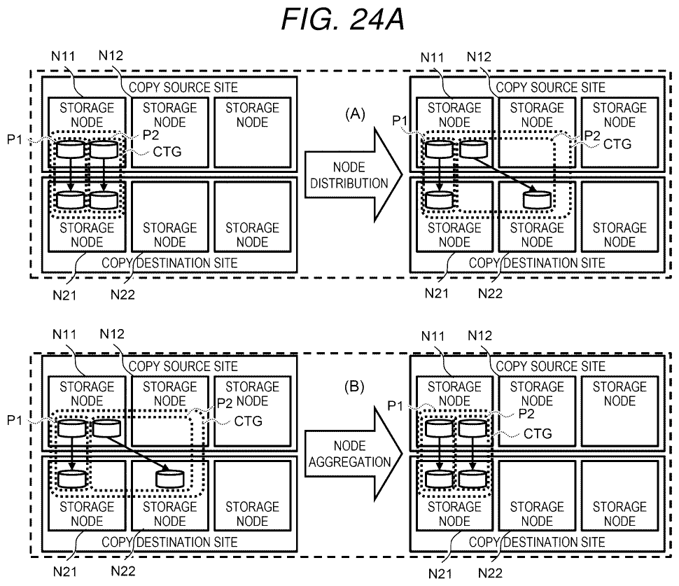

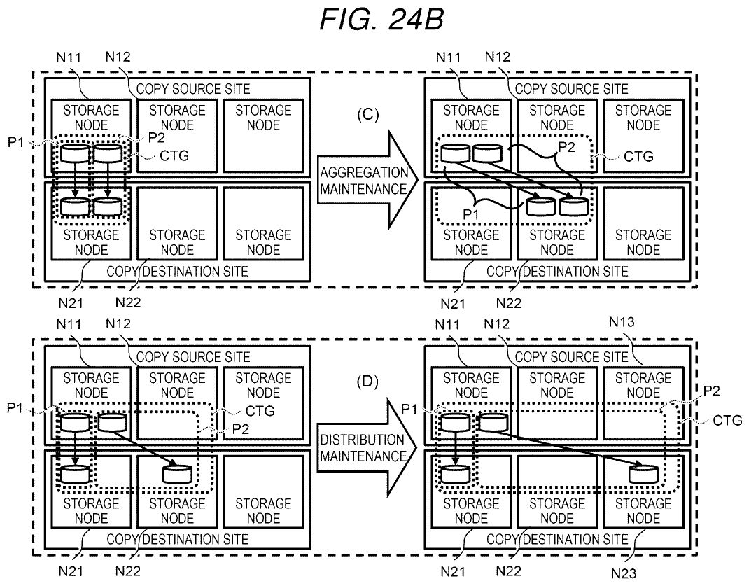

Hereinafter, Embodiment 3 of the invention will be described with reference to FIGS. 24A to 27. In the description of Embodiment 3, differences from the Embodiments 1 and 2 will be mainly described, and redundant description will be omitted.

### Processing Overview of Storage System According to Embodiment 3

FIGS. 24A and 24B are diagrams illustrating a processing overview of a storage system according to Embodiment 3. When a storage employs a CTG, it is necessary to perform copying with consistency within the same CTG. In the invention of the present application, since copying is in a state of being temporarily suspended during volume migration, when considering consistency with other asynchronous copy pairs in the same CTG, it is also necessary to suspend copying of the other asynchronous copy pairs. In the present embodiment, in consideration of this point, copying of all asynchronous copy pairs belonging to the same CTG is suspended during the volume migration.

FIGS. 24A and 24B illustrate, as a premise of the present embodiment, how a CTG configuration changes due to the volume migration.

When a plurality of asynchronous copy pairs belonging to the same CTG are copies within the same storage node, a setting is changed due to the volume migration such that the CTG spans storage nodes. As illustrated in the upper diagram of “(A) node distribution” in FIG. 24A, two asynchronous copy pairs P1 and P2 are copies within the same storage nodes N11 and N21. From this state, a copy destination volume of the asynchronous copy pair P2 is migrated from the storage node N21 to a storage node N22. At this time, the setting of the CTG, which is completed within the storage nodes N11 and N21, is changed to node distribution so as to span the storage nodes N11 and N21 and N12 and N22. A CTG that is set spanning a plurality of storage nodes may be referred to as an ExCTG.

When a plurality of asynchronous copy pairs belonging to the same CTG are copies spanning a plurality of storage nodes, a setting is changed due to the volume migration such that the CTG is completed within the same storage node. As illustrated in the lower diagram of “(B) node aggregation” in FIG. 24A, in a copy source site, the asynchronous copy pair P1 is a copy within the same storage nodes N11 and N21. The asynchronous copy pair P2 is a copy spanning the storage nodes N11 and N21 and N12 and N22. From this state, a copy destination volume of the asynchronous copy pair P2 is migrated from the storage node N22 to the storage node N21. At this time, the CTG, which spans the storage nodes N11 and N21 and N12 and N22, is node-aggregated so as to be completed within the storage nodes N11 and N21.

As illustrated in the upper diagram of “(C) aggregation maintenance” in FIG. 24B, two asynchronous copy pairs P1, P2 are copies within the same storage nodes N11 and N21. From this state, copy destination volumes of the asynchronous copy pairs P1 and P2 are both migrated from the storage node N21 to the storage node N22 while maintaining aggregation. At this time, the CTG, which is configured in the storage nodes N11 and N21, is changed to be configured in the storage nodes N11 and N22.

As illustrated in the lower diagram of “(D) distribution maintenance” in FIG. 24B, the asynchronous copy pair P1 is a copy within the same storage nodes N11 and N21, and the asynchronous copy pair P2 is a copy spanning the storage nodes N11 and N21 and N12 and N22. From this state, a copy destination volume of the asynchronous copy pair P2 is migrated from the storage node N22 to a storage node N23 while maintaining the distribution. At this time, the CTG, which spans the storage nodes N11 and N21 and N12 and N22, is changed so as to span the storage nodes N11 and N21, N12 and N22, and N13 and N23 (or the storage nodes N11 and N21 and N13 and N23).

### Pair Deleting Processing Considering CTG According to Embodiment 3

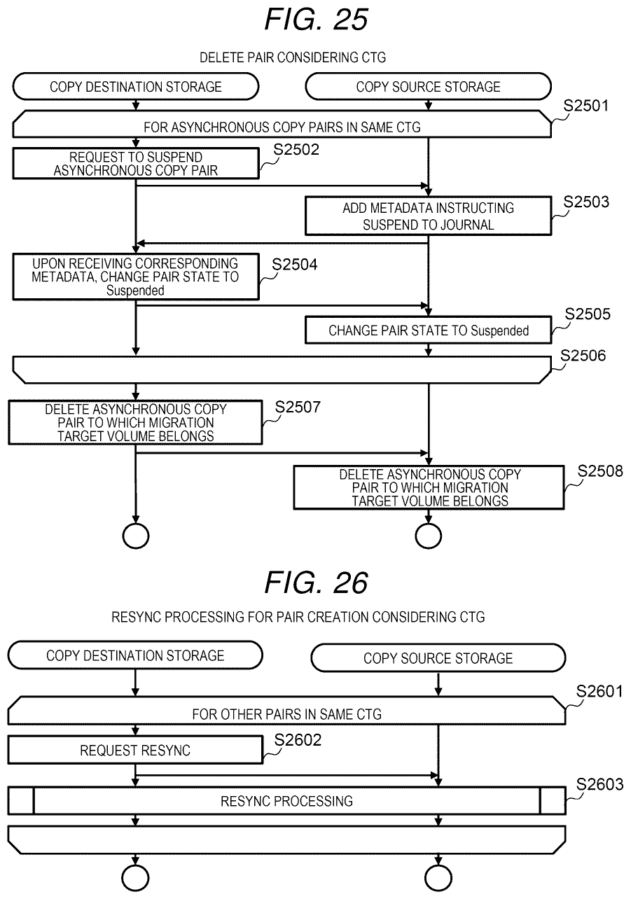

FIG. 25 is a sequence diagram illustrating a pair deleting processing considering the CTG according to Embodiment 3. The pair deleting processing considering the CTG that is illustrated in FIG. 25 is a processing of replacing steps S1605 to S1607 in the copy destination volume migration processing in FIG. 16. The pair deleting processing considering the CTG is a processing of suspending (temporarily suspending copying of) pairs other than a target pair before deleting an asynchronous copy pair.

First, in step S2501 following step S1604, the copy source storage controller and the copy destination storage controller select an unselected asynchronous copy pair among the asynchronous copy pairs within the same CTG.

Next, in step S2502, the copy destination storage controller requests the copy source storage controller to suspend the asynchronous copy pair selected in step S2501. Next, in step S2503, the copy source storage controller adds, to a journal, metadata instructing suspension of the target asynchronous copy pair.

Next, in step S2504, upon receiving the metadata added to the journal in step S2503, the copy destination storage controller changes a pair state of the asynchronous copy pair in the own storage that is selected in step S2501 to suspended. Next, in step S2505, the copy destination storage controller changes the pair state of the asynchronous copy pair in the own storage that is selected in step S2501 to suspended.

Next, in step S2506, when there is an unselected asynchronous copy pair in step S2501, the copy source storage controller and the copy destination storage controller return the processing to step S2501 and select an unselected entry. When all asynchronous copy pairs in the CTG to be selected are selected in step S2501, the copy source storage controller and the copy destination storage controller move the processing to step S2501.

In step S2507, the copy destination storage controller deletes the asynchronous copy pair to which a migration target volume belongs in the own storage. Then, the copy source storage is requested to delete the asynchronous copy pair to which the migration target volume belongs in the copy source storage. In step S2508, the copy source storage deletes the asynchronous copy pair to which the migration target volume belongs in the own storage in response to the deletion request from the copy destination storage controller in step S2507.

When writing to the copy source volume occurs during suspension, an update position is recorded in the copy area management bitmap 131l. That is, 1 is set in the copy required bit for a write destination logical address in the copy area management bitmap creation processing.

Resync Processing for Pair Creation Considering CTG According to Embodiment 3

FIG. 26 is a sequence diagram illustrating a resync processing for pair creation considering the CTG according to Embodiment 3. The resync processing for pair creation considering the CTG that is illustrated in FIG. 26 is a processing executed between steps S1610 and S1611 in the copy destination volume migration processing in FIG. 16.

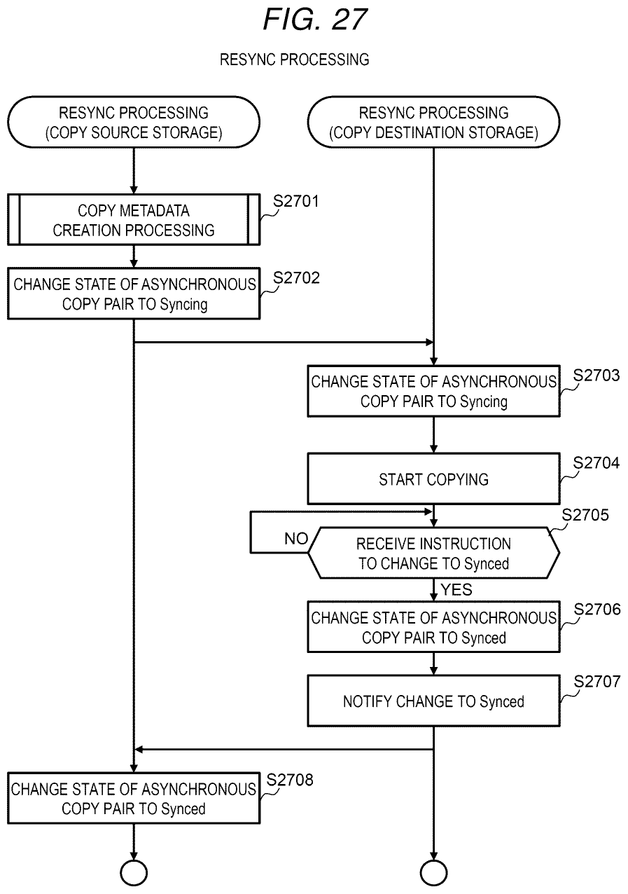

First, in step S2601 following step S1610, the copy source storage controller and the copy destination storage controller select an unselected asynchronous copy pair among the asynchronous copy pairs within the same CTG. Next, in step S2602, the copy destination storage controller requests the copy source storage to perform resync. Next, in step S2603, the copy source storage controller and the copy destination storage controller execute the resync processing in response to a resync request. Details of the resync processing will be described later with reference to FIG. 27.

### Resync Processing According to Embodiment 3

FIG. 27 is a sequence diagram illustrating the resync processing according to Embodiment 3. In the resync processing of the present embodiment, data is resynchronized between two volumes for all volume pairs belonging to the consistency group.

First, in step S2701, the copy source storage controller executes copy metadata creation processing. Details of the copy metadata creation processing are as described in detail with reference to FIG. 21. Next, in step S2702, the copy source storage controller changes a state of the asynchronous copy pair to syncing.

Next, in step S2703, the copy destination storage controller changes the state of the asynchronous copy pair in the own storage, which is an asynchronous copy pair same as that in step S2702, to syncing. Next, in step S2704, the copy destination storage controller starts an asynchronous copy. Next, in step S2705, the copy destination storage controller determines whether special data instructing transition to a synced state is included in the data read from the journal created in step S2701. The copy destination storage controller moves the processing to step S2708 when the special data instructing transition to a synced state is included (YES in step S2705), and repeats step S2705 when the special data is not included (NO in step S2705).

Next, in step S2706, the copy destination storage controller changes the state of the corresponding asynchronous copy pair to synced. Next, in step S2706, the copy destination storage controller notifies the copy source storage controller of completion of the change to synced.

Next, in step S2708, upon receiving the completion of the change to synced from the copy destination storage controller, the copy source storage controller changes the state of the corresponding asynchronous copy pair managed by the copy source storage to synced.

### Effects of Embodiment 3

According to Embodiment 3 described above, the copy destination volume of the asynchronous copy pair can be migrated between the storage nodes of the copy destination storage while maintaining the CTG.

### Embodiment 4

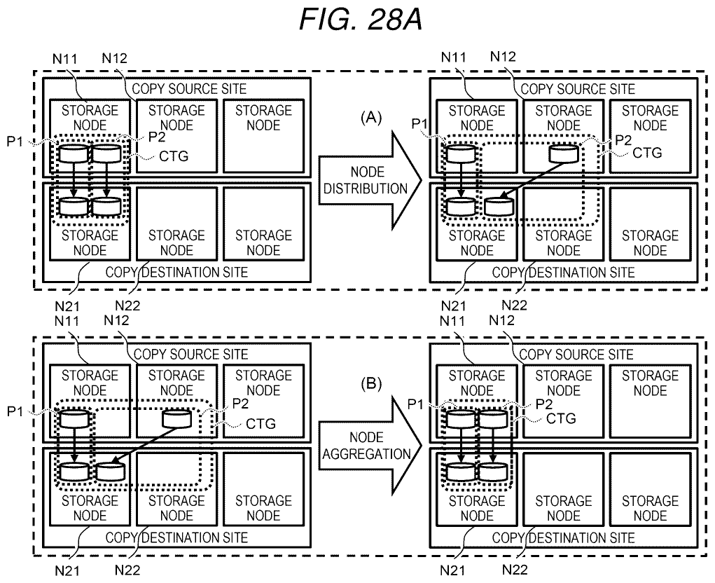

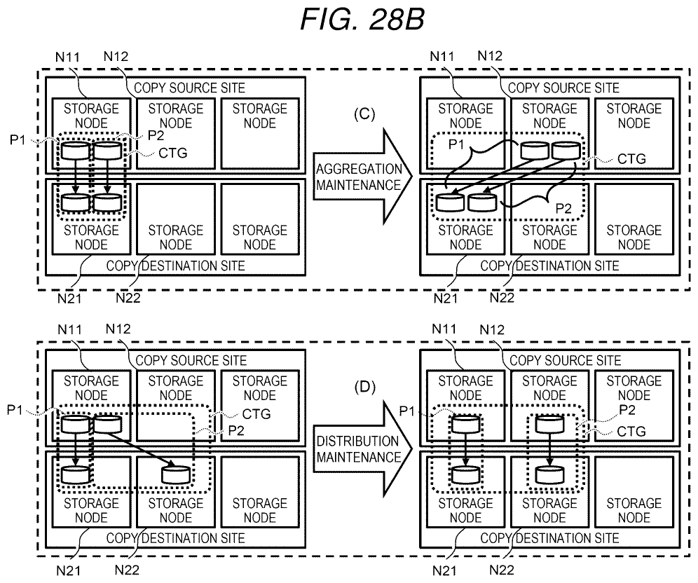

Hereinafter, Embodiment 4 of the invention will be described with reference to FIGS. 28A to 30. In the description of Embodiment 4, differences from Embodiment 1 to 3 will be mainly described, and redundant description will be omitted.

### Processing Overview of Storage System According to Embodiment 4

FIGS. 28A and 28B are diagrams illustrating a processing overview of a storage system according to Embodiment 4. Similar to Embodiment 3 in which load distribution of a copy destination storage node is attempted, when load distribution of a copy source storage node is attempted, in a case where a storage employs a CTG, it is necessary to perform copying with consistency within the same CTG.

FIGS. 28A and 28B illustrate, as a premise of the present embodiment, how a CTG configuration changes due to volume migration.

As illustrated in the upper diagram of “(A) node distribution” in FIG. 28A, two asynchronous copy pairs P1, P2 are copies within the same storage nodes N11, N21. From this state, one copy source volume of the asynchronous copy pair P2 is migrated from the storage node N11 to the storage node N12. At this time, the setting of the CTG, which is completed within the storage nodes N11 and N21, is changed to node distribution so as to span the storage nodes N11 and N21 and N12 and N22.

As illustrated in the lower diagram of “(B) node aggregation” in FIG. 28A, the asynchronous copy pair P1 is a copy within the same storage nodes N11 and N21, and the asynchronous copy pair P2 is a copy spanning the storage nodes N11 and N21 and N12 and N22. From this state, the copy source volume of the asynchronous copy pair P2 is migrated from the storage node N12 to the storage node N11. At this time, the CTG, which spans the storage nodes N11 and N21 and N12 and N22, is node-aggregated so as to be completed within the storage nodes N11 and N21.

As illustrated in the upper diagram of “(C) aggregation maintenance” in FIG. 28B, two asynchronous copy pairs P1, P2 are copies within the same storage nodes N11 and N21. From this state, copy source volumes of the asynchronous copy pairs P1 and P2 are both migrated from the storage node N11 to the storage node N12 while maintaining aggregation. At this time, the CTG, which is completed within the storage nodes N11 and N21, is changed to be completed within the storage nodes N12 and N21.

As illustrated in the lower diagram of “(D) distribution maintenance” in FIG. 28B, the asynchronous copy pair P1 is a copy within the same storage nodes N11 and N21, and the asynchronous copy pair P2 is a copy spanning the storage nodes N11 and N21 and N12 and N22. From this state, a copy source volume of the asynchronous copy pair P2 is migrated from the storage node N11 to the storage node N12 while maintaining the distribution. At this time, the CTG is changed to a setting that spans the storage nodes N11 and N21 and N12 and N22 before and after the volume migration.

### Pair Deleting Processing Considering CTG According to Embodiment 4

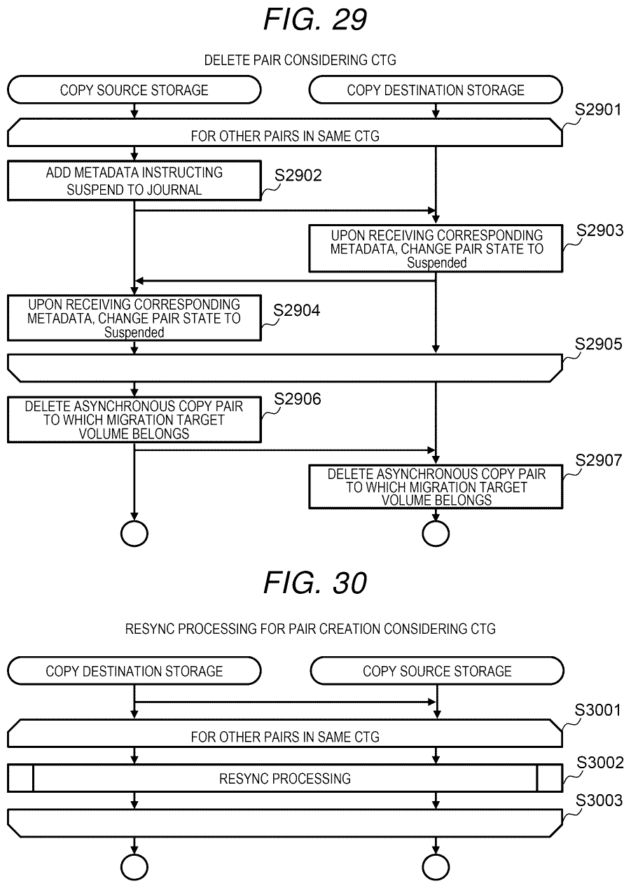

FIG. 29 is a sequence diagram illustrating a pair deleting processing considering the CTG according to Embodiment 4. The pair deleting processing considering the CTG that is illustrated in FIG. 29 is a processing of replacing steps S2305 to S1607 in the copy source volume migration processing in FIG. 23. The pair deleting processing considering the CTG is a processing of suspending (temporarily suspending copying of) pairs other than a target pair before deleting an asynchronous copy pair.

First, in step S2305a following step S2304, a copy source storage controller and a copy destination storage controller select an unselected asynchronous copy pair among the asynchronous copy pairs in the same CTG.

Next, in step S2305b, the copy source storage controller adds, to a journal, metadata instructing suspension of the asynchronous copy pair selected in step S2305a.

Next, in step S2305c, upon receiving the metadata added to the journal in step S2305b, the copy destination storage controller changes a pair state of the asynchronous copy pair in the own storage that is selected in step S1605a to suspended. Next, in step S2305d, the copy source storage controller changes the pair state of the asynchronous copy pair in the own storage selected in step S2305a to suspended.

Next, in step S2305e, when there is an unselected asynchronous copy pair in step S2305a, the copy source storage controller and the copy destination storage controller return the processing to step S2305a and select the unselected asynchronous copy pair. When all asynchronous copy pairs in the CTG to be selected are selected in step S2305a, the copy source storage controller and the copy destination storage controller move the processing to step S2306a.

In step S2306a, the copy source storage controller deletes an asynchronous copy pair to which a migration target volume belongs. Next, in step S2307a, the copy destination storage controller deletes the asynchronous copy pair to which a migration target volume belongs.

### Resync Processing for Pair Creation Considering CTG According to Embodiment 4

FIG. 30 is a sequence diagram illustrating a resync processing for pair creation considering the CTG according to Embodiment 4. The resync processing for pair creation considering the CTG that is illustrated in FIG. 30 is a processing executed between steps S2310 and S2311 in the copy source volume migration processing in FIG. 23.

First, in step S3001 following step S2310, the copy source storage controller and the copy destination storage controller select an unselected asynchronous copy pair among the asynchronous copy pairs in the same CTG. Next, in step S3002, the copy source storage controller and the copy destination storage controller execute the resync processing. Details of the resync processing are as described in detail with reference to FIG. 27.

### Effects of Embodiment 4

According to Embodiment 4 described above, the copy source volume of the synchronous copy pair can be migrated between the storage nodes of the copy source storage while maintaining the CTG.

The invention is not limited to the above-described embodiments, and includes various modifications. The Embodiments described above have been described in detail to describe the invention in an easy-to-understand manner, and the invention is not necessarily limited to including all the described configurations. In addition, the configurations may not only be deleted, but also be replaced or added. Embodiments of the invention also include aspects in which a part or all of the above-described embodiments are appropriately combined to be consistent. The execution order of the processing steps illustrated in the flowcharts of the above-described embodiments can be appropriately changed as long as the processing result does not change.

A part of all of the configurations, functions, processing units, processing methods, or the like described above may be implemented by hardware by, for example, designing with an integrated circuit. The invention can also be implemented by a program code of software for implementing functions of the embodiments. In this case, a recording medium recording the program code is provided to a computer, and a processor provided in the computer reads the program code stored in the recording medium.

In this case, the program code read from the recording medium implements the functions of the embodiments described above by itself, and the program code itself and the recording medium storing the program code implement the invention. Examples of the recording medium for supplying such a program code include a flexible disk, a CD-ROM, a DVD-ROM, a hard disk, a solid state drive (SSD), an optical disk, a magneto-optical disk, a CD-R, a magnetic tape, a non-volatile memory card, and a ROM.

Further, the program code for implementing the functions described in the embodiments can be implemented in a wide range of programs or script languages such as Assembler, C/C++, Perl, Shell, PHP, and Java (registered trademark).

Control lines and information lines considered to be necessary for description are shown in the embodiments described above, and not all control lines and information lines are necessarily shown in a product. All the configurations may be connected.

What is claimed is:

1. A storage system comprising:
storages each including a storage node, the storage node including a storage drive and a storage controller configured to process an I/O request from a host, wherein
a first storage of the storages includes a first volume in a first storage node,
a second storage of the storages includes a second volume in a second storage node,
a first pair relationship of a copy in which data related to the I/O request from the host to the first volume is reflected in the second volume is created between the first volume and the second volume, and
the storage controller
creates a snapshot of the first volume in the first storage,
deletes the first pair relationship to suspend the copy after creating the snapshot,
migrates the first volume or the second volume as a migration target volume to another storage node of the storage having the migration target volume while continuing processing of the I/O request from the host to the first volume,
creates a second pair relationship of the copy between the first volume and the second volume after the first volume or the second volume is migrated to the other storage node,
compares the first volume and the snapshot and identifies difference data between the first volume and the snapshot after creating the second pair relationship, and
reflects the identified difference data in the second volume.

2. The storage system according to claim 1, wherein
the storage controller
sets the second volume as the migration target volume and creates a copy volume by a synchronous copy of the second volume in another storage node different from the second storage node of the second storage while continuing the processing of the I/O request from the host to the first volume after suspending the copy, and
sets the copy volume as a new second volume and creates the second pair relationship between the first volume and the new second volume.

3. The storage system according to claim 1, wherein
the storage controller
creates a copy volume by a synchronous copy of the first volume in another storage node different from the first storage node of the first storage while continuing the processing of the I/O request from the host to the first volume,
creates the snapshot of the copy volume in the other storage node and deletes the first pair relationship to suspend the copy,
switches an access destination of the I/O request from the host from the first volume to the copy volume after suspending the copy, and
sets the copy volume as a new first volume and creates the second pair relationship between the new first volume and the second volume after switching the access destination of the I/O request to the copy volume.

4. The storage system according to claim 1, wherein
the first storage includes a plurality of the first volumes,
the second storage includes a plurality of the second volumes, and
the storage controller
temporarily suspends, when a consistency group for maintaining consistency of a write order is set in a plurality of volume pairs of the first volume and the second volume between which the first pair relationship is created, a copy related to the I/O request for the first volume and the second volume for all volume pairs belonging to the consistency group, and then deletes the first pair relationship.

5. The storage system according to claim 4, wherein
the storage controller
executes a resync to resynchronize data between the first volume and the second volume for all volume pairs belonging to the consistency group after creating the second pair relationship.

6. A volume migration method in a storage system, the storage system including storages each including a storage node, the storage node including a storage drive and a storage controller configured to process an I/O request from a host,
a first storage of the storages including a first volume in a first storage node,
a second storage of the storages including a second volume in a second storage node, and
a first pair relationship of a copy in which data related to the I/O request from the host to the first volume is reflected in the second volume being created between the first volume and the second volume,
the volume migration method comprising:
by the storage controller,
creating a snapshot of the first volume in the first storage;
deleting the first pair relationship to suspend the copy after creating the snapshot;
migrating the first volume or the second volume as a migration target volume to another storage node of the storage having the migration target volume while continuing processing of the I/O request from the host to the first volume;
creating a second pair relationship of the copy between the first volume and the second volume after the first volume or the second volume is migrated to the other storage node;
comparing the first volume and the snapshot and identifying difference data between the first volume and the snapshot after creating the second pair relationship; and
reflecting the identified difference data in the second volume.

7. The volume migration method in the storage system according to claim 6, further comprising:
by the storage controller,
setting the second volume as the migration target volume and creating a copy volume by a synchronous copy of the second volume in another storage node different from the second storage node of the second storage while continuing the processing of the I/O request from the host to the first volume after suspending the copy; and
setting the copy volume as a new second volume and creating the second pair relationship between the first volume and the new second volume.

8. The volume migration method in the storage system according to claim 6, further comprising:
by the storage controller,
creating a copy volume by a synchronous copy of the first volume in another storage node different from the first storage node of the first storage while continuing the processing of the I/O request from the host to the first volume;
creating the snapshot of the copy volume in the other storage and deleting the first pair relationship to suspend the copy;
switching an access destination of the I/O request from the host from the first volume to the copy volume after suspending the copy; and
setting the copy volume as a new first volume and creating the second pair relationship between the new first volume and the second volume after switching the access destination of the I/O request to the copy volume.

9. The volume migration method in the storage system according to claim 6, wherein
the first storage includes a plurality of the first volumes,
the second storage includes a plurality of the second volumes, and
the storage controller temporarily suspends, when a consistency group for maintaining consistency of a write order is set in a plurality of volume pairs of the first volume and the second volume between which the first pair relationship is created, a copy related to the I/O request for the first volume and the second volume for all volume pairs belonging to the consistency group, and then deletes the first pair relationship.

10. The volume migration method in the storage system according to claim 9, further comprising:
by the storage controller,
executing a resync to resynchronize data between the first volume and the second volume for all volume pairs belonging to the consistency group after creating the second pair relationship.
